(19) United States
(12) Patent Application Publication
(10) Pub. No.: US 2013/0055949 A1
(43) Pub. Date: Mar. 7, 2013

(54) HYGIENIC PROTECTION APPARATUS FOR TOUCH PANEL DEVICE

(71) Applicants: Li-Li Lai, Taipei City (TW); Stephen Tsai, New Taipei City (TW); Shao-Yu Hwang, Taipei City (TW)

(72) Inventors: Li-Li Lai, Taipei City (TW); Stephen Tsai, New Taipei City (TW); Shao-Yu Hwang, Taipei City (TW)

(73) Assignee: Hannspree, Inc., New Taipei City (TW)

(21) Appl. No.: 13/338,298

(22) Filed: Dec. 28, 2011

(30) Foreign Application Priority Data
Sep. 1, 2011 (TW) 100131518

(51) Int. Cl. B05C 5/00; B05C 11/00; B65H 16/02

(52) U.S. Cl. 118/37; 242/590; 118/300; 118/46

(57) ABSTRACT

A hygienic protection apparatus for touch panel device is disclosed, in which the apparatus comprises: a touch panel; a host machine electrically connecting with the touch panel; a protecting member comprising a transparent film and at least one film-output element locating at one side of the touch panel, wherein part of the film is received by the film-output element and part of the film covers the touch panel to protect the surface of the touch panel.

### CROSS REFERENCE TO RELATED APPLICATION

This application claims the benefits of the Taiwan Patent Application Serial Number 100131518, filed on Sep. 1, 2011, the subject matter of which is incorporated herein by reference.

### BACKGROUND OF THE INVENTION

1. Field of the Invention

The present invention relates to a hygienic protection apparatus for touch panel device and, more particularly, to a hygienic protection apparatus for touch panel device that is, for example, a protection for the touch panel of an automatic teller machine (ATM), a ticketing machine, or other public devices having a touch panel.

2. Description of Related Art

As well known to those skilled in the art, touch machines such as an automatic teller machine (ATM), a ticketing machine, or an online shopping machine (e.g. the so called “ibon” machine that is usually installed in a convenience store in Taiwan, as shown in FIG. 1), are all equipped with touch panels and are usually being touched by different users' hands and therefore are stained with oils, bacteria, sweat, or virus, etc. While such impurities (i.e. oils, bacteria, sweat, or virus) may cause infectious disease, touch machines being stained with the impurities may generate a pathogen infection path and result with some sanitary or disease problems.

In order to clean those touch machines, an alcoholic solvent is usually used to wipe-off the impurities to keep the surface of the touch panel clean, and such process should be proceeded periodically. However, the cleaning operation needs employees/staff to complete, and the cost of human resource is high. In some cases, the touch panel may be scratched if the cleaning staff is not well trained, or some rigid particles attached at the surface of the cleaning towel may also scratch the touch panel, whereby the lifespan of the touch panel is shortened. Hence, it is not a good way to clean the touch machines.

Therefore, it is desirable to provide an improved hygienic protection apparatus for touch panel device to avoid impurities (e.g. oils, bacteria, sweat, or virus) attaching to the touch panel, and which can self-clean without extra manpower so as to improve public-sanitation (public health).

### SUMMARY OF THE INVENTION

The present invention provides a hygienic protection apparatus for touch panel device, which comprises: a touch panel and a host machine electrically connecting with the touch panel, the hygienic protection apparatus comprising a transparent film; and at least one film-output element locating at one side of the touch panel, wherein part of the transparent film is received by the film-output element and part of the film covers the touch panel to protect a surface of the touch panel.

According to the present invention, the transparent film enables the images displayed by the touch panel to transmit and enables the avoidance of impurities such as oils, bacteria, sweat, or virus contaminating the touch panel. Therefore, pathogen infections and sanitary or disease problems can be mitigated by the protecting device in the hygienic protection apparatus for touch panel device of the present invention.

According to the present invention, the transparent film can be “page-changed” after being used by a user. In detail, part of the transparent film that covers the touch panel will move out from the touch panel after use, and a newly unused part of the transparent film will be moved to cover the touch panel. When applying the present invention to a touch machine having a touch panel (e.g. an automatic teller machine (ATM), a ticketing machine, or an online shopping machine), the touch panel thereof has been covered with the transparent film, even though the touch machine has been operated by different users, the impurities (i.e. oils, bacteria, sweat, or virus) are not spread (from one person to anther person), and the sanitary conditions of the machine can be improved. Besides, the cost of human resource can be reduced in that there is no need for excess periodic cleaning process, and the risk of causing scratches (due to improper cleaning actions of the staff or rigid particles) can be lowered. Therefore, the hygienic protection apparatus for touch panel device of the present invention can self-keep in a high state of cleanness, whereas the lifespan of the touch panel can be lengthened, and the public sanitary condition can be improved. Consequently, the hygienic protection apparatus for touch panel device of the present invention has a high economic value.

According to the present invention, the material of the transparent film is preferably selected from the group consisted of: plastics (e.g. polymers such as PP, PET, PVC, PE), starch (i.e. eco-materials such as cornstarch), resin, and mixtures thereof.

According to the present invention, the at least one film-output element may preferably comprise at least one output roll. For example, the film-output element can be a single output roll, or two output rolls that clip and output the transparent film to the touch panel.

The present invention may preferably further comprise a liquid-spraying member locating on one side of the touch panel, the liquid-spraying member is preferably filled with a liquid, and the liquid-spraying member preferably sprays the liquid on the transparent film. Dependent upon the needs, the liquid can be, for example, a disinfecting agent, a cleaning agent, a fragrance agent, an alcoholic agent, a detergent, or mixtures thereof.

The present invention may preferably further comprise an actuating element and a motor, in which the actuating element preferably connects with the motor, and the motor preferably connects to the film-output element. The actuating element preferably is a button (or a page-changing button) or an infrared-sensing element, in which the button and the infrared-sensing element can be alternatively used. Thereby, when the button is pressed or some action or human movement is detected by the infrared-sensing element, the motor will start to actuate (i.e. rotate) the film-output element and therefore to page-change the transparent film. Herein, the term “page-change” means that the part of the transparent film (having a length about the length or width of the touch panel) that covers the touch panel will move out from the touch panel after use, and a newly unused part of the transparent film will be moved to cover the touch panel. The length of the transparent film that is output every time by the film-output element is preferably about the length or width of the touch panel.

The present invention may preferably further comprise an automatic film-changing member, the automatic film-changing member preferably receives a signal from the host machine and page-changes the transparent film depending on the signal. Herein, the action of “page-change” can be proceeded by controlling the film-output element or the film-trapping element by the automatic film-changing member.

The present invention may preferably further comprise a film-trapping element locating at the side opposite to the film-output element of the touch panel. The film-trapping element can receive and/or trap the used transparent film.

The present invention may preferably further comprise a handle connecting to the film-trapping element, and therefore the transparent film can be manually page-changed by the handle.

The present invention may preferably further comprise an actuating element and a motor, the actuating element connects with the motor, the motor connects to the film-trapping element or the film-output element, and the actuating element is a button or an infrared-sensing element. The motor may selectively connect to the film-trapping element or the film-output element in order to control the page-changing operation of the film-trapping element or the film-output element.

The present invention may preferably further comprise a printing member locating at one side of the touch panel. The printing member can print information such as transaction detail, tickets, coupon, figures, other characters etc. on the transparent film.

The present invention may preferably further comprise a cutting member locating at one side of the printing member. The cutting member can be any item that is used to cut or tear the transparent film, and the cutting member may preferably be a blade, a cutting wheel, or a tearing bar (such as a plastic bar, a wood bar, or a ruler).

According to the present invention, the hygienic protection apparatus for touch panel device is preferably located on an automatic teller machine (ATM), a ticketing machine, or an online shopping machine. For example, the hygienic protection apparatus for touch panel device may be on an ATM, ibon, or ticketing machine installed in post-offices, banks, malls, or transit stations.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an “ibon” machine that is usually installed in convenience stores in Taiwan;

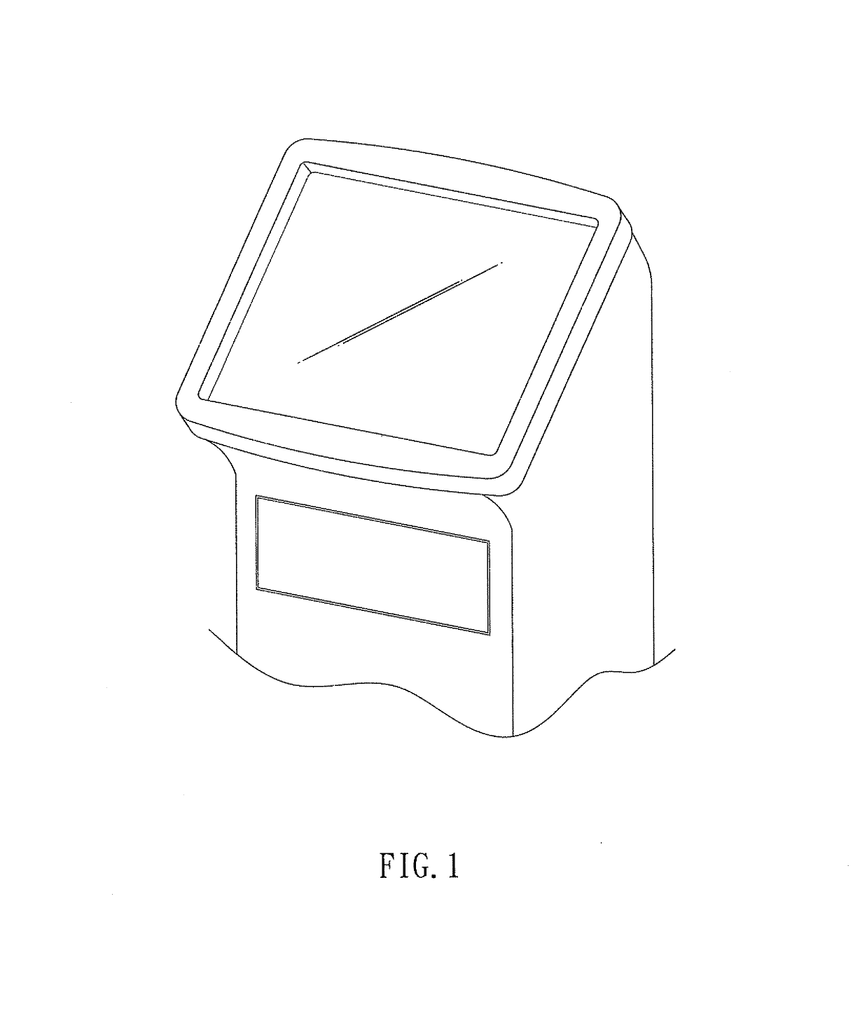

FIG. 2 is a perspective view of a hygienic protection apparatus for touch panel device of the example 1.

FIG. 3 is a perspective view of a hygienic protection apparatus for touch panel device of the example 2.

FIG. 4 is a perspective view of a hygienic protection apparatus for touch panel device of the example 3.

### DETAILED DESCRIPTION OF THE PREFERRED EMBODIMENT

### Example 1

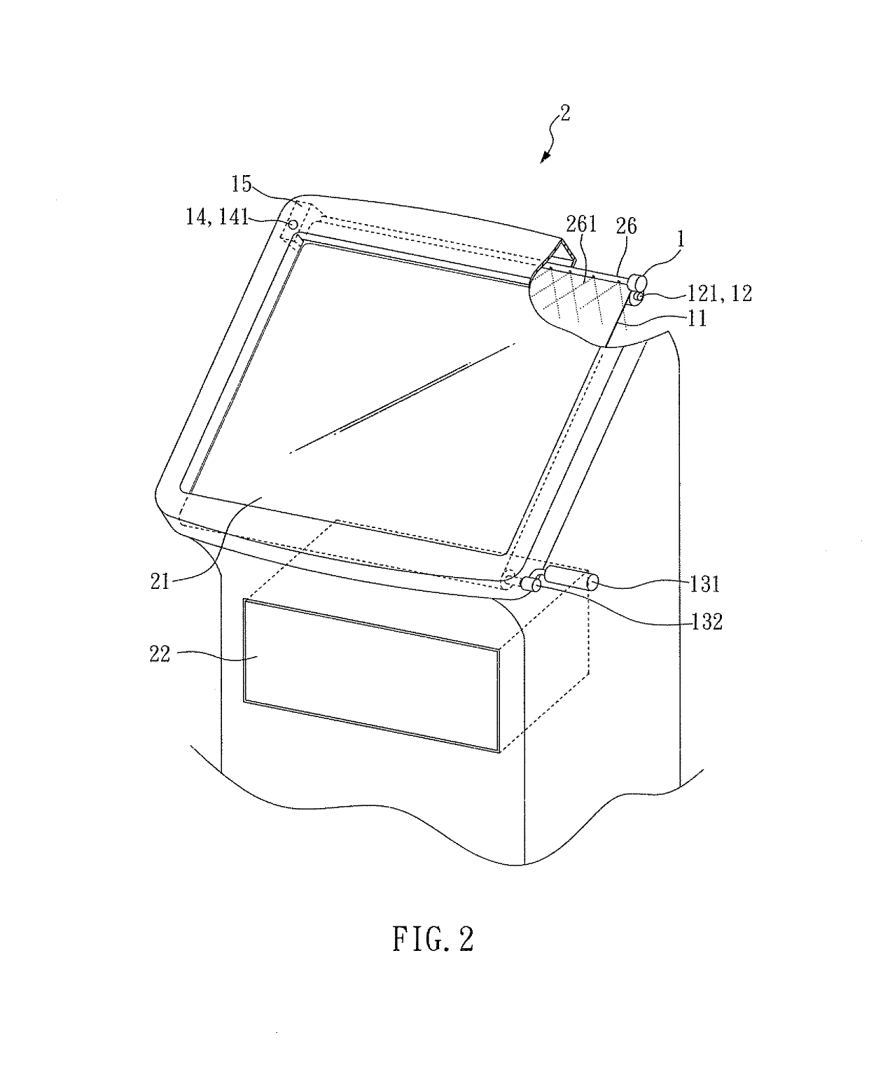

With reference to FIG. 2, there is shown a hygienic protection apparatus for touch panel device 2 of the present example. The hygienic protection apparatus for touch panel device 2 comprises: a touch panel 21; a host machine 22 electrically connecting with the touch panel 21; a protecting member 1 comprising a transparent film 11 and a film-output element 12 locating at one side of the touch panel 21, wherein part of the transparent film 11 is received by the film-output element 12 and part of the transparent film 11 covers the touch panel 21 to protect the surface of the touch panel 21.

In the present example, the transparent film 11 is made of PVC (poly(vinyl chloride)), but is not limited thereto. The transparent film 11 may also be made of, for example, transparent materials such as PP, PET, PVC, or PE; starch (an eco-material such as cornstarch); resin; and mixtures thereof.

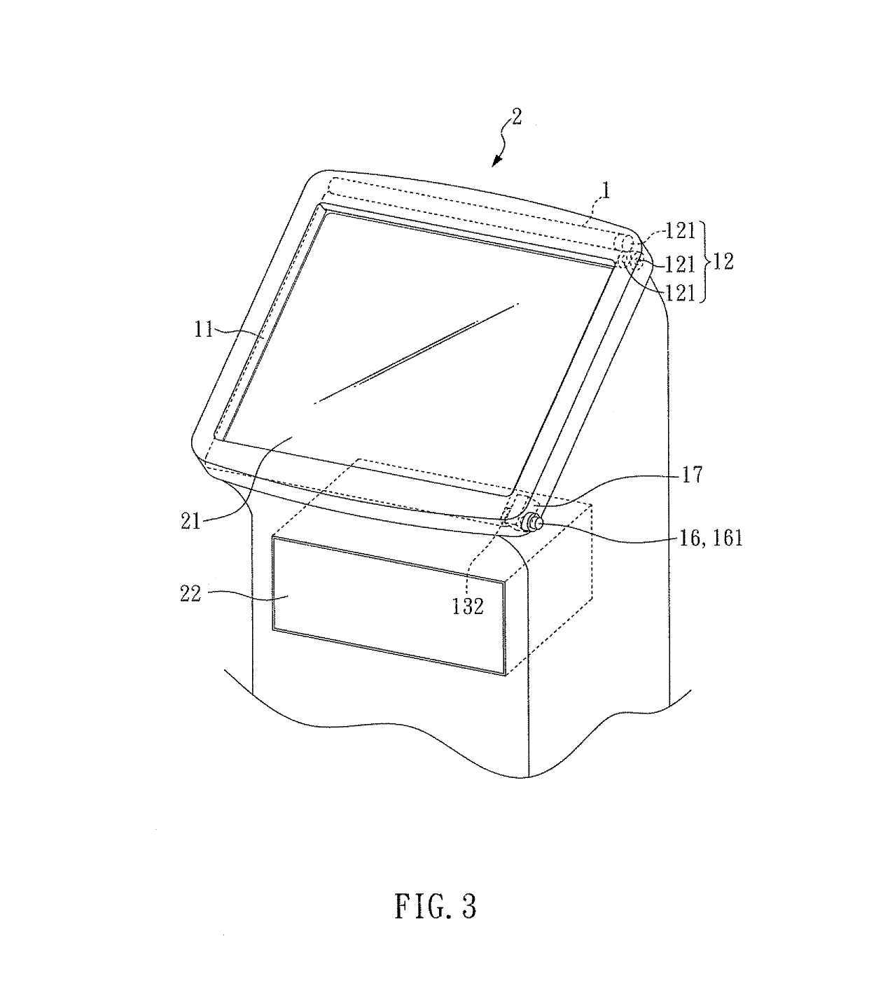

Herein, the film-output element 12 is an output roll 121 used to output the transparent film 11. The film-output element 12 may also comprise two or more output rolls 121 that clip and output the transparent film 11 to the touch panel 21, as shown in FIG. 3.

In the present example, the protecting device 1 comprises a liquid-spraying member 26 locating on one side of the touch panel 21, the liquid-spraying member 26 is filled with a liquid 261, and the liquid-spraying member 26 sprays the liquid 261 on the surface of the transparent film 11. The liquid 261 can be, for example, a disinfecting agent, a cleaning agent, a fragrance agent, an alcoholic agent, a detergent, mixtures thereof, or other functional liquids. Herein, the liquid 261 in this example is an alcohol.

In the present example, an actuating element 14 and a motor 15 is set at the left-upper corner of the touch panel 21, the actuating element 14 is an infrared-sensing element 141 and is connecting to the motor 15. The motor 15 connects to the film-output element 12. Therefore, when some action or human movement is detected by the infrared-sensing element 141, the motor 15 will start to actuate (i.e. rotate) the film-output element 12 and therefore to page-change the transparent film 11. Herein, the length of the transparent film 11 that is output every time by the film-output element 12 is preferably about the length or width of the touch panel 21. Alternatively, the actuating element 14 may be a button (not shown) so that when the button is pressed, the motor 15 will start to actuate (i.e. rotate) the film-output element 12 and therefore to page-change the transparent film 11.

A film-trapping element 132 and a handle 131 connecting to the film-trapping element 132 are set at the bottom side of the touch panel 21, the film-trapping element 132 locates at the side opposite to the film-output element 132 of the touch panel 21. The film-trapping element 132 can receive and/or trap the used transparent film 11, and the handle 131 is used to manually control the page-change of the transparent film 11 and adjust the flatness of the transparent film 11 locating on the surface of the touch panel 21.

In the present example, the hygienic protection apparatus for touch panel device 2 is an automatic teller machine (ATM), but is not limited thereto. The hygienic protection apparatus for touch panel device 2 may also be a ticketing machine, or an online shopping machine (e.g. an ATM, ibon, or ticketing machines installed in the post-offices, banks, malls, or transit stations).

Therefore, according to the hygienic protection apparatus for touch panel device 2 having a protecting member 1 of the present invention, since the touch panel 21 thereof has been covered with the transparent film 11, even though the touch panel device 2 (e.g. an automatic teller machine (ATM), a ticketing machine, or an online shopping machine) has been operated by different users, the impurities (i.e. oils, bacteria, sweat, or virus) are not spread (from one person to anther person), and the sanitary conditions of the machine can be improved. Besides, the human resource cost can be reduced in that there is no need of excess periodic cleaning process, and the risk of causing scratches (due to improper cleaning actions of the staff or rigid particles) can be lowered. Therefore, the hygienic protection apparatus for touch panel device of the present invention can self-keep in a high state of cleanness, whereas the lifespan of the touch panel can be lengthened, and the public sanitary condition can be improved. Consequently, the hygienic protection apparatus for touch panel device of the present invention has a high economic value.

### Example 2

As shown in FIG. 3, the hygienic protection apparatus for touch panel device 2 of the present example comprises the elements as those included in the example 1, for example, a touch panel 21, a host machine 22, a transparent film 11, and a film-trapping element 132. Moreover, the present example further comprises three output rolls 121, thus the transparent film 11 is rolled by one of the output roll 121 and is clipped and output to the touch panel 21 by the other two output rolls 121. The hygienic protection apparatus for touch panel device 2 of the present example also comprises an actuating element 16 and a motor 17, the actuating element 16 connects to the motor 17, and the actuating element 16 is a button 161 (may also be an infrared-sensing element as in the example 1). The motor 17 connects to and/or controls the film-trapping element 132 and enables the film-trapping element 132 to rotate and trap and/or receive the used transparent film 11. The motor 17 may selectively electrically connect to and/or control the film-output element 12, and is not limited thereto. The main function of the motor 17 herein is to assist the proceeding of the page-changing process.

### Example 3

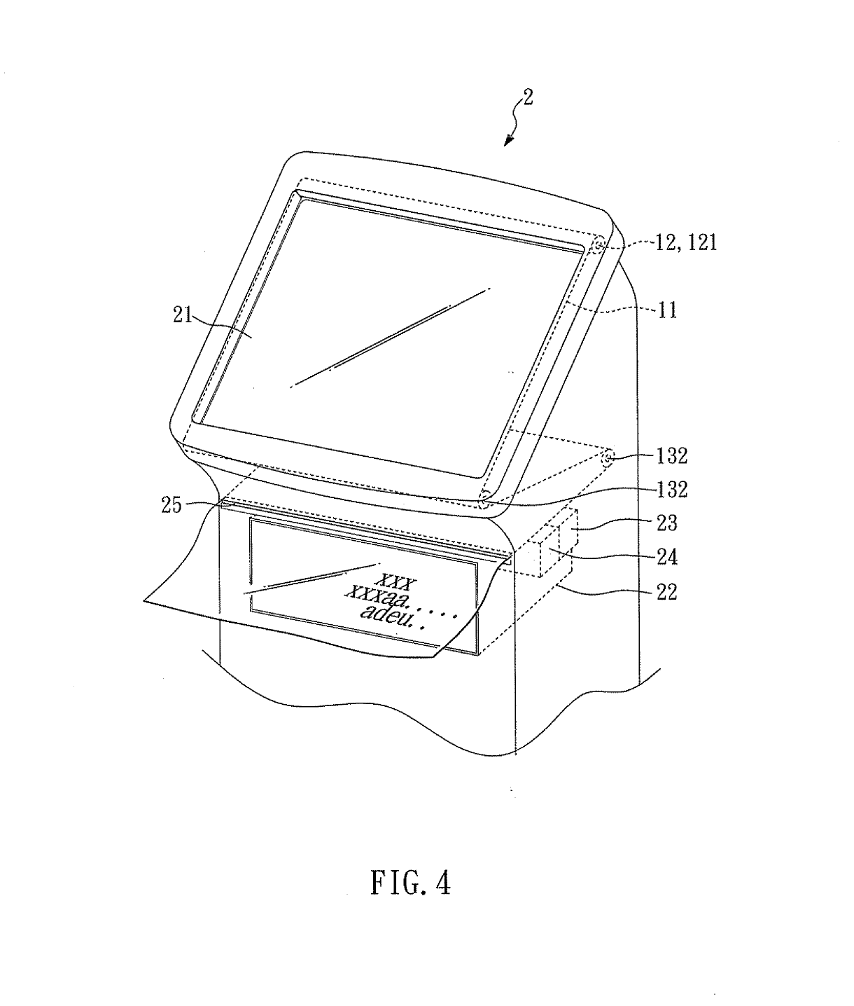

Reference with FIG. 4, the hygienic protection apparatus for touch panel device 2 of the present example comprises the elements as those included in the example 1, for example, a touch panel 21, a host machine 22, a transparent film 11, and a film-trapping element 132. Moreover, the present example further comprises an automatic film-changing member 23, the automatic film-changing member 23 receives a signal (not shown) from the host machine 22 and page-changes the transparent film 11 depending on the signal. Herein, the term “page-change” means that the part of the transparent film 11 (having a length about the length or width of the touch panel) that covers the touch panel 21 will move out from the touch panel 21 after used, and a newly unused part of the transparent film 11 will be moved to the touch panel 21. The page-changing action in the present example is controlled by the automatic film-changing member 23. In detail, the automatic film-changing member 23 controls the film-output element 12 or the film-trapping element 132 to complete the page-changing operation.

Besides, the hygienic protection apparatus for touch panel device 2 of the present example further comprises a printing member 24 (e.g. a laser-printer) locating at one side of the touch panel 21. The printing-device 24 prints information from the host machine, for example, receipts, tickets, lotteries, coupons, or the like, on the transparent film 11 when the operation by the user is done.

In the present example, the hygienic protection apparatus for touch panel device 2 further comprises a cutting member 25 locating at one side of the printing member 24. The cutting member 25 cuts the transparent film 11 that is printed with information by the printing member 24. And the cut transparent film 11 can be carried by the user. The cutting member 25 can be any item that is used to cut or tear the transparent film, and the cutting member may preferably be a blade, a cutting wheel, or a tearing bar (such as a plastic bar, a wood bar, or a ruler). Herein, the cutting member 25 is a blade.

As aforementioned, according to the present invention, the transparent film can be “page-changed” after being used by a user. In detail, part of the transparent film that covers the touch panel will move out from the touch panel after use, and a newly unused part of the transparent film will be moved to the touch panel. Therefore, when applying the present invention to a touch machine having a touch panel (e.g. an automatic teller machine (ATM), a ticketing machine, or an online shopping machine), since the touch panel thereof has been covered with the transparent film, even though the touch machine has been operated by different users, the impurities (i.e. oils, bacteria, sweat, or virus) are not spread (from one person to anther person), and the sanitary conditions of the machine can be improved. Besides, the human resource cost can be reduced in that there is no need of excess periodic cleaning process, and the risk of causing scratches (due to improper cleaning actions of the staff or rigid particles) can be lowered. Therefore, the hygienic protection apparatus for touch panel device of the present invention can self-keep in a high state of cleanness, whereas the lifespan of the touch panel can be lengthened, and the public sanitary condition can be improved. Consequently, the hygienic protection apparatus for touch panel device of the present invention has a high economic value.

Although the present invention has been explained in relation to its preferred embodiment, it is to be understood that many other possible modifications and variations can be made without departing from the spirit and scope of the invention as hereinafter claimed.

What is claimed is:

1. A hygienic protection apparatus for touch panel device, which comprises a touch panel and a host machine electrically connecting with the touch panel, the hygienic protection apparatus comprising:
a transparent film; and
at least one film-output element locating at one side of the touch panel, wherein part of the transparent film is received by the film-output element and part of the transparent film covers the touch panel to protect a surface of the touch panel.

2. The hygienic protection apparatus for touch panel device as claimed in claim 1, wherein the material of the transparent film is selected from the group consisted of: plastics, starch, resin, and mixtures thereof.

3. The hygienic protection apparatus for touch panel device as claimed in claim 1, wherein the at least one film-output element comprises at least one output roll.

4. The hygienic protection apparatus for touch panel device as claimed in claim 1, further comprises a liquid-spraying member locating on one side of the touch panel and filled with a liquid, and the liquid-spraying member sprays the liquid on the transparent film.

5. The hygienic protection apparatus for touch panel device as claimed in claim 1, further comprises an actuating element and a motor, the actuating element connects with the motor, and the motor connects to the film-output element.

6. The hygienic protection apparatus for touch panel device as claimed in claim 5, wherein the actuating element is a button or an infrared-sensing element.

7. The hygienic protection apparatus for touch panel device as claimed in claim 1, further comprises an automatic film-changing member, the automatic film-changing member receives a signal from the host machine and page-changes the transparent film depending on the signal.

8. The hygienic protection apparatus for touch panel device as claimed in claim 1, further comprises a film-trapping element locating at the other side opposite to the film-output element of the touch panel.

9. The hygienic protection apparatus for touch panel device as claimed in claim 8, further comprises a handle connecting to the film-trapping element.

10. The hygienic protection apparatus for touch panel device as claimed in claim 8, further comprises an actuating element and a motor, the actuating element connects with the motor, the motor connects to the film-trapping element or the film-output element, and the actuating element is a button or an infrared-sensing element.

11. The hygienic protection apparatus for touch panel device as claimed in claim 1, further comprises a printing member locating at one side of the touch panel.

12. The hygienic protection apparatus for touch panel device as claimed in claim 11, further comprises a cutting member locating at one side of the printing member.

13. The hygienic protection apparatus for touch panel device as claimed in claim 1, wherein the hygienic protection apparatus for touch panel device is attached to an automatic teller machine (ATM), a ticketing machine, or an online shopping machine.
